(19) United States
(12) Patent Application Publication
(10) Pub. No.: US 2025/0189938 A1
(43) Pub. Date: Jun. 12, 2025

(54) METHOD AND SYSTEM TO AUTOMATICALLY OPTIMIZE WELL MANAGEMENT IN SYSTEMS OF WELLS

(71) Applicant: ExxonMobil Technology and Engineering Company, Spring, TX (US)

(72) Inventors: Chong Hyun AHN, Houston, TX (US); Lingxiao ZHANG, Sugar Land, TX (US); Benjamin J. SPIVEY, Spring, TX (US); Neal L. ADAIR, Spring, TX (US); Ge YUAN, Spring, TX (US); Manjunath R. NALLAPUSALA, Spring, TX (US); Amr S. EL-BAKRY, Houston, TX (US); Brock B. ARGYLE, Spring, TX (US); Emmanouil KARANTINOS, Tomball, TX (US)

(21) Appl. No.: 18/903,413

(22) Filed: Oct. 1, 2024

Related U.S. Application Data
(60) Provisional application No. 63/607,730, filed on Dec. 8, 2023.

(51) Int. Cl. G05B 13/02; E21B 41/00; E21B 47/00; G05B 13/04

(52) U.S. Cl. CPC G05B 13/0265; E21B 41/00; E21B 47/00; G05B 13/048; E21B 2200/20; E21B 2200/22

(57) ABSTRACT

A methodology for optimizing the recovery from a system of wells is provided. The method is executed via a processor of a computing system. The method includes receiving input data for a system of wells. The method also further includes predicting, via a trained virtual flow meter, virtual flow rates for the system of wells for a scenario using a predicted pressure and temperature for the scenario. The predicted pressure and temperature are generated based on the input data. The method includes generating a production optimization recommendation based on the predicted virtual flow rates and a received rule for the system of wells. The method includes adjusting a manipulative parameter of a well in the system of wells based on production optimization recommendation.

### CROSS-REFERENCE TO RELATED APPLICATION

This application claims priority to and the benefit of U.S. Provisional Application No. 63/607,730, entitled “METHOD AND SYSTEM TO AUTOMATICALLY OPTIMIZE WELL MANAGEMENT IN SYSTEMS OF WELLS,” having a filing date of Dec. 8, 2023, the disclosure of which is incorporated herein by reference in its entirety.

### FIELD

The present application relates generally to the field of hydrocarbon management. Specifically, the disclosure relates to a methodology for the optimization of production of a system of wells.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Production Surveillance and Optimization (PSO) represents monitoring and analyzing the responses from a given well or field and performing adequate actions to optimize performance of the well or field based on a specified objective function. Variables that may be manipulated or changed to reach such an optimum may include, but is not limited to choke, artificial lift, workover and improved oil recovery settings such as water, chemical, and/or CO₂ injection rates.

However, there are challenges in PSO space that are not addressed very well by existing PSO workflows and models. One challenge relates to high well count. High well count is a common problem that persists in unconventional assets. Operators may be operating thousands of existing wells with new wells coming online every month. Typically, one production engineer may be assigned to look after 50-200 wells. Such an assignment may place stringent time constraints on production optimization work. Moreover, sustaining and maintaining thousands of models may be almost impossible.

A second challenge relates to the dynamic and complex behavior of wells. In particular, the interference between adjacent wells and dramatic transient, dynamic pressure, and rate behavior are common challenges. Moreover, recently emerging challenges such as flare mitigation efforts may require near real-time prediction of such dynamic and complex well behaviors.

A third challenge relates to the use of various artificial lift and workover techniques. In this regard, the lifecycle of an unconventional shale well usually involves natural flow and various artificial lift applications, such as those using electronic submersible pumps (ESPs), gas lift, gas assisted plunger lift (GAPL), sucker rod pump, etc. Having a prediction capability corresponding to such manipulative variables is very challenging considering the sophisticated physics involved in these applications.

### SUMMARY

An aspect provided herein relates to a method for managing a system of wells. The method, which is executed by a processor of a computing system, can include receiving input data for the system of wells. The method can also include predicting, via a trained virtual flow meter, virtual flow rates for the system of wells for a scenario using a predicted pressure and temperature for the scenario. The predicted pressure and temperature are generated based on the input data. The method can further include generating a production optimization recommendation based on the predicted uplift from virtual flow rates and a received rule for the system of wells. The method can also include adjusting a manipulative parameter of a well in the system of wells based on a production optimization recommendation.

Another aspect provided herein relates to a method for training virtual flow meters. The method, which is executed by a processor of a computing system, can include receiving historical well test data, well static data, completion data, reservoir parameters, and well measurements such as a temperature and a pressure. The method can further include training a virtual flow meter using multivariate supervised machine learning and using a predicted pressure and temperature that is based on the historical well test data, the well static data, the completion data, the reservoir parameters, and the well measurements.

These and other features and attributes of the disclosed embodiments of this disclosure and their advantageous applications and/or uses will be apparent from the detailed description that follows.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a process flow diagram of an exemplary method for training a predictive soft sensor to predict changes in temperature and pressure, in accordance with this disclosure;

FIG. 2 is a schematic view of an exemplary method for automatically generating optimization recommendations based predicted flow rates in accordance with this disclosure;

FIG. 3 is a schematic view of an exemplary method for updating models using active learning based on prediction uncertainty and error, in accordance with this disclosure;

FIG. 4 is a schematic view of an exemplary method for automatically retraining models using feedback, in accordance with this disclosure;

FIG. 5 is a block diagram of an exemplary system that can automatically generate optimization recommendations for a system of wells, in accordance with this disclosure;

FIG. 6 is a block diagram of an exemplary cluster computing system that may be utilized to implement this disclosure; and

FIG. 7 is a block diagram of an exemplary non-transitory, computer-readable storage medium that may be used for the storage of data and modules of program instructions for implementing this disclosure.

It should be noted that the figures are merely examples of this disclosure and are not intended to impose limitations on the scope of this disclosure. Further, the figures are generally not drawn to scale, but are drafted for purposes of convenience and clarity in illustrating various aspects of the techniques.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, artificial lift refers to any system that adds energy to the fluid column in a wellbore with the objective of initiating and improving production from the well. Artificial lift systems may use a range of operating principles, including rod pumping, gas lift, and electric submersible pumps.

As used herein, the phrase “based on” does not mean “based only on,” unless expressly specified otherwise. In other words, the phrase “based on” means “based only on,” “based at least on,” and/or “based at least in part on.”

As used herein, the term “battery” refers to installation of similar or identical units of equipment in a group, such as a separator battery, header battery, filter battery, or tank battery. The phrase “battery site” refers to a portion of land that contains separators, treaters, dehydrators, storage tanks, pumps, compressors, and other surface equipment in which fluids coming from a well are separated, measured, or stored.

As used herein, the term “choke” refers to a device incorporating an orifice that is used to control fluid flow rate or downstream system pressure. Chokes are available in several configurations for both fixed and adjustable modes of operation. Adjustable chokes enable the fluid flow and pressure parameters to be changed to suit process or production requirements.

As used herein, the terms “example,” exemplary,” and “embodiment,” when used with reference to one or more components, features, structures, or methods according to this disclosure, are intended to convey that the described component, feature, structure, or method is an illustrative, non-exclusive example of components, features, structures, or methods according to this disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of this disclosure.

The term “geophysical data” as used herein broadly includes seismic data, as well as other data obtained from non-seismic geophysical methods such as electrical resistivity. In this regard, examples of geophysical data include, but are not limited to, seismic data, gravity surveys, magnetic data, electromagnetic data, well logs, image logs, radar data, or temperature data.

Generally speaking, the term “pressure” refers to a force acting on a unit area. Pressure is typically provided in units of pounds per square inch (psi).

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

As used herein, “hydrocarbon management”, “managing hydrocarbons” or “hydrocarbon resource management” includes any one, any combination, or all of the following: hydrocarbon extraction; hydrocarbon production, (e.g., drilling a well and prospecting for, and/or producing, hydrocarbon recovery, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, “water injection rate” refers to the rate of water injected into the reservoir to pressurize and displace hydrocarbons to producing wells.

As used herein, “workover” refers to the repair or stimulation of an existing production well for the purpose of restoring, prolonging or enhancing the production of hydrocarbons.

If there is any conflict in the usages of a word or term in this specification and one or more patent or other documents that may be incorporated herein by reference, the definitions that are consistent with this specification should be adopted for the purposes of understanding this disclosure.

### Overview

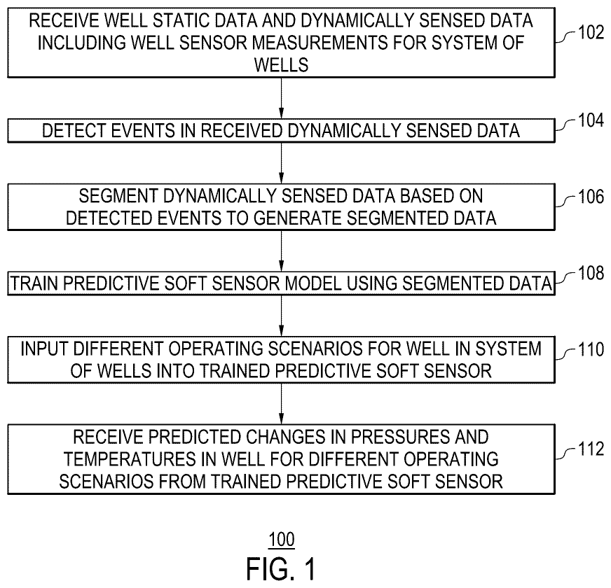

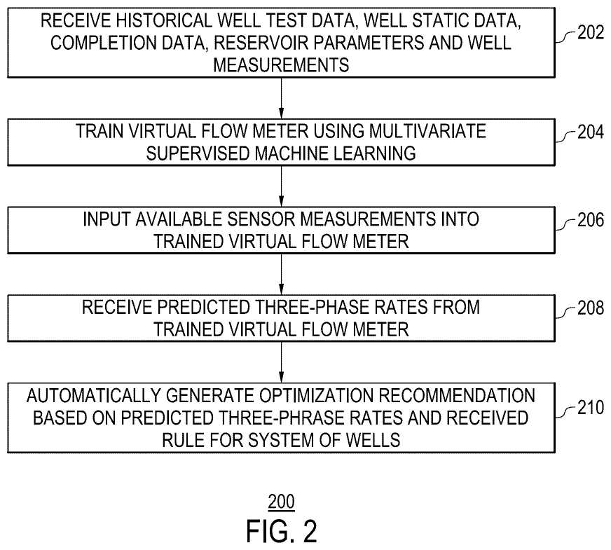

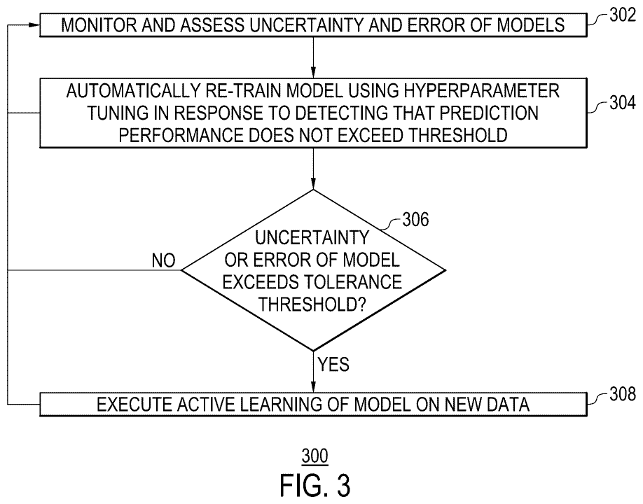

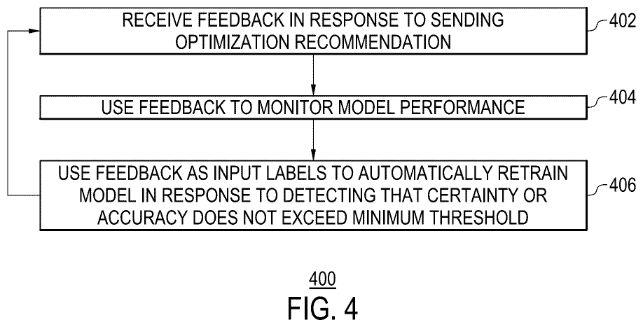

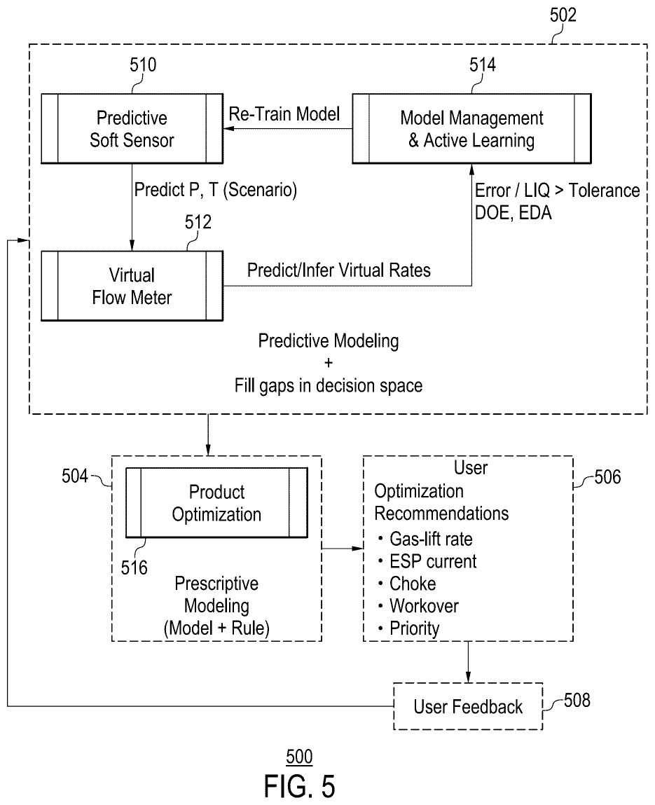

This disclosure provide an automated means of predicting flow rates and generating optimization recommendations for a system of wells. The optimization generation procedure can be implemented by training a predictive model leveraging static and dynamically sensed data from a system of wells. In various embodiments, the techniques may include four parts. In the first part, a predictive soft sensor is trained using well static data and dynamically sense data from a system of wells. An example training procedure is described with respect to FIG. 1. In the second part, a virtual flow meter is trained to predict three-phase rates using multivariate supervised machine learning. An example training procedure is described with respect to FIG. 2. In a third part, an active learning process is utilized in response to detecting that uncertainty or prediction error of a model is not sufficient. An example active learning process is described with respect to FIG. 3. In a fourth part, feedback is received in response to transmitted optimization recommendations and used as both a source of monitoring model performance and as labels for re-training models. An example process utilizing such feedback is described with respect to FIG. 4. A system combining these techniques to automatically generate optimization recommendations is described with respect to FIG. 5.

This disclosure may derive one or more benefits. First, the automated modeling management, active learning, and user feedback loop of this disclosure enable robustness, while ensuring a competitive prediction performance above a reasonable threshold to optimize production operation. Additionally, embodiments described herein enable the automated prediction of three-phase (oil, water, gas) rates in different operating scenarios including choke, artificial lift, and workover. Second, the methodology provides an automated simplified means of efficiently maintaining model quality. Moreover, initial prototyped models have demonstrated that present techniques can be implemented using a number of different statistical and data analysis techniques and machine learning algorithms, including time-series machine learning techniques. Thus, any range of different statistical and data analysis techniques and machine learning algorithms can be used depending on the target prediction performance and robustness.

### Temperature and Pressure Prediction Techniques

FIG. 1 is a schematic view of an exemplary method for training a predictive soft sensor to predict changes in temperature and pressure, in accordance with this disclosure. The exemplary method starts at block 102, where static data and dynamically sensed data including high frequency well measurements of a system of wells is received. For example, the high frequency well measurements may be received at increments of time within the range of a few seconds to a minute. In various embodiments, the data may be preprocessed using various quality control and quality assurance algorithms, as described in greater detail with respect to FIG. 5 below.

At block 104, events are detected in the received dynamically sensed data. For example, the detected events may include manual choke events, master valve events, Emergency Shutdown (ESD) events, slugging events, liquid loading events, gas lift setpoint change events, among other types of detected events.

At block 106, the dynamically sensed data is segmented based on the detected events to generate segmented data. For example, the dynamically sensed data may be segmented based on a detected pressure change in build-up and draw-down.

At block 108, a predictive soft sensor is trained using the segmented data. For example, the predictive soft sensor can be trained based on observed and labeled events in the field detected from multiple wells.

At block 110, different operating scenarios for a well in the system of wells are input into the trained predictive soft sensor. For example, the different operating scenarios may include values of various parameters, such as ESD signal, or manual choke changes.

At block 112, predicted changes in pressures and temperatures in the well are received from the predictive soft sensor for the different operating scenarios.

Those skilled in the art will appreciate that the exemplary method 100 of FIG. 1 is susceptible to modification without altering the technical effect provided by this disclosure. In practice, the exact manner in which the method 100 is implemented will depend, at least in part, on the details of the specific implementation. For example, in some embodiments, some of the blocks shown in FIG. 1 may be altered or omitted from the method 100 and/or new blocks may be added to the method 100. For example, in some embodiments, the method 100 may further include adjusting one or more manipulative parameters in one or more wells of system of wells based on predicted changes in pressures and temperatures.

### Flow Rate Prediction and Production Recovery Optimization Techniques

FIG. 2 is a schematic view of an exemplary method for automatically generating optimization recommendations based on predicted flow rates in accordance with this disclosure. The example method 200 of FIG. 2 outlines an example workflow to train a virtual flow meter to predict three-phase rates and generate optimization recommendations for a system of wells using the trained virtual flow meter. The method 200 may start at block 202, where historical well test data, well static data, completion data, reservoir parameters and high frequency well measurements are received. For example, the well measurement data may include temperature and pressure measurement. In various examples, the well measurement data may be received from field measurements of temperatures, pressures, or both. In some examples, the data can also be received from predictive soft sensor output when field measurements are inaccurate or not available. For example, predicted temperatures and predicted pressures may be received from the predictive soft sensor for a future event.

At block 204, a virtual flow meter is trained using multivariate supervised machine learning. For example, the historical well test data, well static data, completion data, reservoir parameters and high frequency well measurements may be input into a machine learning model along with ground truth labels. The machine learning model may then be trained using any suitable techniques. For example, the training may be performed using backpropagation to adjust model parameters using any suitable loss function, such as mean squared error. In various examples, gradient descent, such as stochastic gradient descent, may be used to iteratively optimize the loss function. In various examples, a number of models may be trained. For example, a model may be trained for each phase rate. In some examples, for one phase rate, the training may also build models to predict the high-side, low-side, and median rates. In some examples, additional models can also be trained using hyperparameter tuning experiments. For example, multiple models for the same prediction may be generated and the best model may then be selected based on given metric. As one example, the given metric may be mean absolute percent error (MAPE).

At block 206, available sensor measurements are input into the trained virtual flow meter. For example, the available sensor measurements include any data that is available for the system, including static data and real-time dynamically received data from a number of sensors. The real-time dynamically received data may be high-frequency input data, such as data received at a rate on the order of hertz. For example, the high-frequency input data may be received at a rate within the range of a few seconds to a minute.

At block 208, predicted three-phase rates are received from the trained virtual flow meter for a number of different scenarios. For example, the different scenarios may be various combinations of values for any combination of manipulative variables, such as choke, artificial lift, workover and water injection rate.

At block 210, optimization recommendations are automatically generated based on the predicted three-phase rates and a received rule. For example, an optimizer may receive one or more rules specifying gas rate constraints from a flare limit and analyze the predicted three-phase rates to determine a combination of values for manipulative variables that would result in an overall maximization of production for the system of wells. As one example, the optimizer may be a Mixed-Integer Linear Programming optimizer. In various examples, the recommended manipulative variables may include artificial lift rate, such as a gas-lift rate, ESP current, choke, workover, and priority. In various embodiments, one or more of the manipulative parameters of one or more wells in the system of wells may then be adjusted based on the optimization recommendations. For example, the optimization recommendations may be transmitted to one or more users, such as operations, production engineers, or well people. The users may then adjust the one or more manipulative parameters that may include choke, artificial lift rate, workover, and water injection rate, among other potential manipulative parameters. In this manner, the method 200 may enable total recovery of the system of wells to be maximized.

Those skilled in the art will appreciate that the exemplary method 200 of FIG. 2 is susceptible to modification without altering the technical effect provided by this disclosure. In practice, the exact manner in which the method 200 is implemented will depend, at least in part, on the details of the specific implementation. For example, in some embodiments, some of the blocks shown in FIG. 2 may be altered or omitted from the method 200 and/or new blocks may be added to the method 200.

FIG. 3 is a schematic view of an exemplary method for updating models using active learning based on prediction uncertainty and error, in accordance with this disclosure. The example method 300 of FIG. 3 outlines an example workflow to update models. The exemplary method 300 starts at block 302, where the uncertainty and error of models are monitored and assessed.

At block 304, a model is automatically re-trained using hyperparameter tuning in response to detecting that prediction performance does not exceed threshold.

At decision diamond 306, a determination is made as to whether an uncertainty or error of any of the models exceeds tolerance threshold. If the uncertainty or error of the models does not exceed the tolerance threshold, then the method may continue at block 302. If the uncertainty or error of a model exceeds the tolerance threshold, then the method may continue at block 308.

At block 308, active learning of the model is executed on new data. In various examples, active learning may include prescribing modifications to one or more manipulative variables in response to detecting that historical data used to train the models does not have enough information regarding the effect of the prescribed modification. Thus, in this manner, the method 300 can automatically interrogate the information space for which sensory data is not yet available. In various embodiments, the model may be re-trained using additional data collected in response to execution of the prescribed modification.

Those skilled in the art will appreciate that the exemplary method 300 of FIG. 3 is susceptible to modification without altering the technical effect provided by this disclosure. In practice, the exact manner in which the method 300 is implemented will depend, at least in part, on the details of the specific implementation. For example, in some embodiments, some of the blocks shown in FIG. 3 may be altered or omitted from the method 300 and/or new blocks may be added to the method 300.

FIG. 4 is a schematic view of an exemplary method for automatically retraining models using feedback, in accordance with this disclosure. The example method 400 of FIG. 4 outlines an example workflow to utilize feedback received in response to optimization recommendations. The method 400 may start at block 402, where feedback is received in response to sending optimization recommendation.

At block 404, the feedback is used to monitor model performance. For example, the feedback may include whether the optimization recommendation improved performance, or the extent to which the optimization recommendation actually improved performance. As one example, a production engineer in the field can label an ESD event or slugging event.

At block 406, the feedback is used as input labels to automatically retrain model in response to detecting that certainty or accuracy does not exceed minimum threshold. For example, a model for a predictive soft sensor or a model for a virtual flow meter may be automatically retrained in response to detecting that the model does not exceed the minimum threshold for certainty or minimum threshold for accuracy. As shown using an arrow, the method may continue at block 402, where additional feedback is received in response to sending a subsequent optimization recommendation. For example, the subsequent optimization recommendation may have been generated using the retrained model.

Those skilled in the art will appreciate that the exemplary method 400 of FIG. 4 is susceptible to modification without altering the technical effect provided by this disclosure. In practice, the exact manner in which the method 400 is implemented will depend, at least in part, on the details of the specific implementation. For example, in some embodiments, some of the blocks shown in FIG. 4 may be altered or omitted from the method 400 and/or new blocks may be added to the method 400.

Exemplary System Implementing this Disclosure

FIG. 5 is a block diagram of an exemplary system 500 that can automatically generate optimization recommendations for a system of wells. The system 500 includes a predictive modeling unit 502 communicatively coupled to a prescriptive modeling unit 504. The prescriptive modeling unit 504 includes a product optimization module 516. The system 500 also includes a user device 506 communicatively coupled to the predictive modeling unit 502 and the prescriptive modeling unit 504. The user device 506 is shown generating feedback 508 that is transmitted to the predictive modeling unit 502. The predictive modeling unit 502 further includes a predictive soft sensor 510 coupled to a virtual flow meter (VFM) 512. The predictive modeling unit 502 also further includes a model management and active learning unit 514 communicatively coupled to the predictive soft sensor 510 and the virtual flow meter 512.

The system 500 can predict the flow rates of a given well in a system of wells with uncertainty and also perform various optimization actions. For example, the flow rates may include oil, water, and gas flow rates. In some embodiments, the workflow of the system 500 may include the four parts described above, including soft sensing, inferred production, automated model managements and Active Learning, and the use of a user feedback loop, as described in the methods 100-400 of FIGS. 1-4. In general, well test data and other sensor data from the system of wells are validated and quality analyzed (QA) and quality controlled (QC) as descriptive analytics. For example, a separator is used to measure rates provided in the dynamically sensed data. Such a separator may be validated to ensure that it is providing accurate representative rates. In some examples, the quality of the data may be assured based on if a tag exists or not. For example, a basic sanity check may be performed to discard any values that are not possible. As one example of such a sanity check, negative values may be discarded where an absolute value scale is being used. For example, negative flow rates or negative pressure may be filtered out. Moreover, a dynamic form of quality checking may also be used for dynamically sensed data. For example, values may be compared with previously received values to determine whether changes in the values are physically realistic. In this regard, the first derivative or second derivative of the input values over time may be used to compare against a threshold rate of change and discard any values exceeding such threshold. In this manner, values indicating instantaneous step changes may be discarded, as well as series of values indicating no changes where no change is impossible. For example, such values may be caused by technical issues in the sensors rather than changes in operating conditions. Such validation and quality control may provide a solid foundation enabling the surveillance of assets. In various embodiments, the observations are based on and quality controlled based on intuition from physics. For example, the downhole pressure may be checked to be within a range of pounds per square inch (PSI) or Pascal (Pa) values. As another example, fluids may be checked to be flowing in the direction of decreasing pressure. As yet another example, reservoir temperatures cannot be 250 Fahrenheit, or 121.11 degrees Celsius. The system 500 may thus be physics-assisted. With the application of soft sensing, inferred production and automated model management and Active Learning, predictive analytics is performed through series of supervised machine learning models and statistical techniques. In some embodiments, the system 500 is further enhanced by prescriptive analytics of scenario explorations, optimization while integrating user feedback, production operation best practices, and uncertainty quantification.

In various embodiments, the main objective of the predictive soft sensor 502 is to obtain the best prediction of changes in pressure and temperature of a given well due to a change in operating conditions. For example, such changes in operating conditions may include choke changes, artificial lift parameter changes, or workovers, among other operating condition changes. In some embodiments, the predictive soft sensor 502 is a combination of unsupervised event detection and segmentation (change in manipulated variables), response surface modeling and multivariate machine learning models using high frequency well measurements and well static data. In particular, due to changing reservoir conditions, choke change versus pressure changes relationship is modeled as a function of time. The soft sensing algorithm of the predictive soft sensor 502 detects the events, segments the data and performs the model training on segmented data instead of building a model from hypothetical assumptions or from laboratory experiments. Thus, detected special events such as a reservoir build-up will be identified from a segment and become a part of training dataset.

In various examples, the unsupervised event detection may be performed using Time-series analysis and signal processing on static data and dynamic data. For example, various well sensors may provide high frequency downhole, tubing head, and flow line, pressures and temperature data. Long term pressure data may provide quantitative information about the well and reservoir behavior for different operating scenarios. Examples of detected events may include reservoir pressure build-up or draw-down, ESD, slugging events, among other types of events.

The segmentation performed by the predictive soft sensor 502 may be performed using any suitable segmentation algorithm. For example, the segmentation algorithm used may be a change point detection algorithm.

The predictive soft sensor 502 uses machine learning methods to learn from the rich set of well sensor data and predict changes in pressures, temperatures for different operating scenarios. In various embodiments, the training of the multivariate machine learning models may include the use of regression and Bayesian methods. The predictive soft sensor 510 can extract pressure and temperature as a function of the manipulative variables. For example, the predictive soft sensor 510 can thus extract the pressure/temperature relationship versus manipulative variables such as choke, artificial lift and workovers directly from the field measurements. In various examples, the predictive soft sensor 510 can also quantify uncertainty of the algorithm output in terms of changes in pressure and temperature and provide potential errors and uncertainties in the used features, such as choke changes, artificial lift parameter changes or workovers.

The Virtual Flow Meter (VFM) 512 inferred production is the model that predicts three-phase rates from available sensor measurements such as downhole, tubing head, flowline pressures and temperatures. For example, the three-phase rates may include gas, oil, and water rates. In some embodiments, a multivariate supervised machine learning approach is used to train a predictive model to learn statistical relationship between historical well test data, well static data, completion data, reservoir parameters and high frequency well measurements. In some embodiments, methods such as Bayesian and/or quantile regression are used to quantify the uncertainty of the predictions.

In various embodiments, the trained and tuned models of the predictive soft sensor 502 and Virtual Flow Meter (VFM) 512 are sustained and maintained utilizing a Machine Learning Operations (MLOps) framework. MLOps provides a framework for managing a machine learning lifecycle effectively and efficiently. In some embodiments, the MLOps framework is part of the model management and active learning unit. Models are retrained on fixed frequency to take into account new well tests or trigger by error threshold. Revisions of models and key parameters/metrics are stored. Prediction (or inference) can then performed based on a most recent revision of the model. In some examples, older models can be retrieved to rerun on historical data for reference.

The MLOps framework can be used to provide a robust and automated way of re-training, monitoring and assessing model performance through uncertainty and error. For example, when a model prediction performance is below desired threshold, hyperparameters tuning and Active Learning are used to improve model qualities of the predictive soft sensor 510 and VFM 512. In some embodiments, an active learning may be used to tackle weaknesses of the data-driven approach, such as extrapolation. In general, the model management and active learning unit 514 can use an automated field experiment workflow to train machine learning models based on design of experiment (DOE) and explanatory data analysis (EDA). If the uncertainty of the prediction or error exceeds the tolerance, then the management and active learning unit 514 may proceed to use an active learning model. As one example, active learning may be performed during an extended well test duration. For example, the active learning model may utilize a portion of time to train the model by introducing data that the model has never trained on before.

In various embodiments, the user device 506 may include an interactive tool with an automated feedback loop. The system 500 can then receive user feedback 508 to use as input to the machine learning model to capture high quality labels to the machine learning model as well as a source of monitoring model performance to efficiently maintain model quality. For example, the high quality labels may be captured by manual labeling from production engineers and thus closer to the observation of production engineers than automatically generated labels. In some embodiments, hyperparameter tuning to enhance accuracy/performance of prediction or feature engineering can be triggered based on the user feedback 508. For example, hyperparameter tuning may be used to optimize hyperparameters to enhance predictive performance of machine learning model. As one example of hyperparameter tuning, a user may use hyperparameter tuning to train a model for gas rate for more stringent error criteria compared to a well test. Feature Engineering may be used to drive right form input in terms of quantity and quality to a machine learning model and thus enhance performance. As one example of feature engineering, ESP related features such as ESP current may be added to train an oil flow rate model.

Thus, the system 500 supports not only retrospective analysis, but also forward planning.

The model management and active learning unit 514 can actively manage a number of models for the system of wells. For example, the model management and active learning unit 514 can manage a number of models for each well in the system of wells, including predictive soft sensor models and virtual flow meter models. In various embodiments, the model management and active learning unit 514 can provide version tracking of the models, as well as tracking which versions of the models are currently being used and when the models were last updated. In this manner, the model management and active learning unit 514 can enable a fully automated system.

### Exemplary Cluster Computing System for Implementing Present Techniques

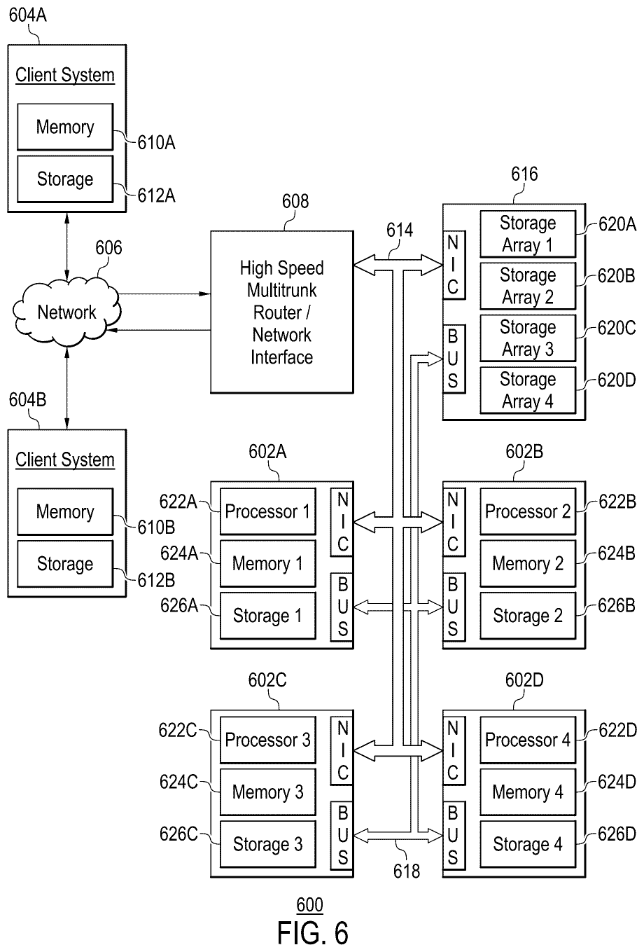

FIG. 6 is a block diagram of an exemplary cluster computing system 600 that may be utilized to implement this disclosure. The exemplary cluster computing system 600 shown in FIG. 6 has four computing units 602A, 602B, 602C, and 602D, each of which may perform calculations for a portion of this disclosure. However, one of skill in the art will recognize that the cluster computing system 600 is not limited to this configuration, as any number of computing configurations may be selected. For example, a smaller analysis may be run on a single computing unit, such as a workstation, while a large calculation may be run on a cluster computing system 600 having tens, hundreds, thousands, or even more computing units.

The cluster computing system 600 may be accessed from any number of client systems 604A and 604B over a network 606, for example, through a high-speed network interface 608. The computing units 602A to 602D may also function as client systems, providing both local computing support and access to the wider cluster computing system 600.

The network 606 may include a local area network (LAN), a wide area network (WAN), the Internet, or any combinations thereof. Each client system 604A and 604B may include one or more non-transitory, computer-readable storage media for storing the operating code and program instructions that are used to implement this disclosure. For example, each client system 604A and 604B may include a memory device 610A and 610B, which may include random access memory (RAM), read only memory (ROM), and the like. Each client system 604A and 604B may also include a storage device 612A and 612B, which may include any number of hard drives, optical drives, flash drives, or the like.

The high-speed network interface 608 may be coupled to one or more buses in the cluster computing system 600, such as a communications bus 614. The communication bus 614 may be used to communicate instructions and data from the high-speed network interface 608 to a cluster storage system 616 and to each of the computing units 602A to 602D in the cluster computing system 600. The communications bus 614 may also be used for communications among the computing units 602A to 602D and the cluster storage system 616. In addition to the communications bus 614, a high-speed bus 618 can be present to increase the communications rate between the computing units 602A to 602D and/or the cluster storage system 616. Each of the components may receive information communicated via the communications bus 614 with a network interface card (NIC).

The cluster storage system 616 can have one or more non-transitory, computer-readable storage media, such as storage arrays 620A, 620B, 620C and 620D for the storage of models, data (including core data relating to one or more wells), visual representations, results (such as graphs, charts, and the like used to convey results obtained using this disclosure), code, and other information concerning the implementation of this disclosure. The storage arrays 620A to 620D may include any combinations of hard drives, optical drives, flash drives, or the like.

Each computing unit 602A to 602D can have a processor 622A, 622B, 622C and 622D and associated local non-transitory, computer-readable storage media, such as a memory device 624A, 624B, 624C and 624D and a storage device 626A, 626B, 626C and 626D. Each processor 622A to 622D may be a multiple core unit, such as a multiple core central processing unit (CPU) or a graphics processing unit (GPU). Each memory device 624A to 624D may include ROM and/or RAM used to store program instructions for directing the corresponding processor 622A to 622D to implement this disclosure. Each storage device 626A to 626D may include one or more hard drives, optical drives, flash drives, or the like. In addition, each storage device 626A to 626D may be used to provide storage for models, intermediate results, data, images, or code associated with operations, including code used to implement this disclosure.

This disclosure are not limited to the architecture or unit configuration illustrated in FIG. 6. For example, any suitable processor-based device may be utilized for implementing all or a portion of embodiments of this disclosure, including without limitation personal computers, laptop computers, computer workstations, mobile devices, and multi-processor servers or workstations with (or without) shared memory. Moreover, embodiments may be implemented on application specific integrated circuits (ASICs) or very-large-scale integrated (VLSI) circuits. In fact, persons of ordinary skill in the art may utilize any number of suitable structures capable of executing logical operations according to embodiments described herein.

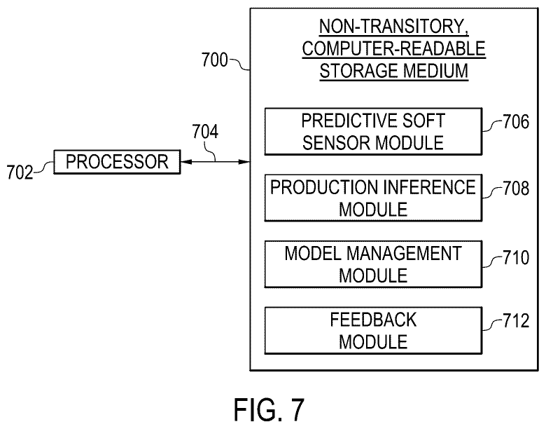

FIG. 7 is a block diagram of an exemplary non-transitory, computer-readable storage medium 700 that may be used for the storage of data and modules of program instructions for implementing this disclosure. The non-transitory, computer-readable storage medium 700 may include a memory device, a hard disk, and/or any number of other devices, as described herein. A processor 702 may access the non-transitory, computer-readable storage medium 700 over a bus or network 704. While the non-transitory, computer-readable storage medium 700 may include any number of modules (and sub-modules) for implementing this disclosure, in some embodiments, the non-transitory, computer-readable storage medium 700 includes a predictive soft sensor module 706. The predictive soft sensor module 706 may include instructions to cause the processor 702 to perform the functions of the predictive soft sensor 510 described herein.

Furthermore, in some embodiments, the non-transitory, computer-readable storage medium 700 includes a production inference module 708. In addition, in some embodiments, the non-transitory, computer-readable storage medium 700 includes a model management module 710. Also included is a feedback module 712. In this manner, the techniques described herein provide a practical application that directly improves the efficiency and accuracy of modelling pressure and temperature in a system of wells, and thus enables inferred virtual rates to be generated for a variety of scenarios. The techniques thus further enable optimization of production rates for the overall system by generating recommended manipulative variables, such as gas-lift rate, ESP current, choke, workover, and priority.

Although embodiments herein are described with respect to the unconventional oil extraction, one skilled in the art will readily recognize that the techniques described herein are also suitable for application in other areas. For example, such applications may include carbon storage applications, among other applications within hydrocarbon management. It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of this disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, this disclosure include all alternatives, modifications, and equivalents falling within the true spirit and scope of the appended claims.

What is claimed is:

1. A method for managing a system of wells, wherein the method is executed via a processor of a computing system, and wherein the method comprises:
receiving input data for system of wells;
predicting, via a trained virtual flow meter, virtual flow rates for the system of wells for a scenario using a predicted pressure and temperature for the scenario, wherein the predicted pressure and temperature are generated based on the input data;
generating a production optimization recommendation based on the predicted uplift from virtual flow rates and a received rule for the system of wells; and
adjusting a manipulative parameter of a well in the system of wells based on a production optimization recommendation.

2. The method of claim 1, comprising generating the input data using a trained predictive soft sensor.

3. The method of claim 2, wherein the trained predictive soft sensor comprises an unsupervised event detector and a data segmenter, wherein the trained predictive soft sensor trains a supervised predictive model to predict the pressure and temperature responses using segmented data generated from detected events.

4. The method of claim 2, wherein the trained predictive soft sensor and virtual flow meter are trained to quantify and output uncertainty of the predicted pressures and temperatures.

5. The method of claim 1, wherein the input data comprises well static data and dynamically sensed data.

6. The method of claim 1, wherein generating the production optimization recommendation comprises calculating an inferred production for a plurality of scenarios based on the predicted virtual flow rates and generating the production optimization recommendation based on an inferred production that maximizes overall production of the system of wells.

7. The method of claim 1, wherein predicting the virtual flow rates comprises inputting available sensor measurements into the virtual flow meter and receiving predict three-phase rates from the trained virtual flow meter.

8. The method of claim 1, wherein the virtual flow meter is trained using multivariate machine learning including but not limited to supervised, unsupervised, and/or stochastic based on received historical well test data, well static data, completion data, reservoir parameters, and high frequency well measurements.

9. The method of claim 1, wherein the trained predictive soft sensor or the trained virtual flow meter is automatically re-trained in response to detecting that a prediction performance based on error and uncertainty of the trained predictive soft sensor or the trained virtual flow meter does not exceed a threshold.

10. The method of claim 1, comprising receiving feedback in response to the production optimization recommendation and using the feedback to capture labels to use as input for retraining the trained predictive soft sensor and the trained virtual flow meter.

11. The method of claim 1, comprising receiving feedback in response to the production optimization recommendation and monitoring model performance based on the feedback.

12. The method of claim 1, comprising receiving feedback in response to the production optimization recommendation and executing hyperparameter tuning based on the feedback.

13. The method of claim 1, comprising receiving feedback in response to the production optimization recommendation and executing feature engineering based on the feedback.

14. The method of claim 1, comprising executing an active learning on new data in response to detecting that an uncertainty or an error of a model of the trained predictive soft sensor and the trained virtual flow meter exceeds a tolerance threshold.

15. The method of claim 1, wherein the active learning comprises prescribing a modification to one or more manipulative variables in response to detecting that historical data used to train the models does not have enough information regarding the effect of the prescribed modification.

16. The method of claim 1, wherein the production optimization recommendation comprises a prescribed modification to a gas-lift rate.

17. The method of claim 1, wherein production optimization recommendation comprises a prescribed modification to a workover.

18. The method of claim 1, wherein the production optimization recommendation comprises a prescribed modification to a priority.

19. The method of claim 1, wherein adjusting a manipulative parameter of a well in the system of wells includes user feedback.

20. The method of claim 1, wherein the input data comprises dynamically sensed high-frequency well measurements.

21. A method for training virtual flow meters, wherein the method is executed via a processor of a computing system, and wherein the method comprises:
receiving historical well test data, well static data, completion data, reservoir parameters, and well measurements including a temperature and a pressure; and
training a virtual flow meter using multivariate supervised machine learning and using a predicted pressure and temperature that is based on the historical well test data, the well static data, the completion data, the reservoir parameters, and the well measurements.

22. The method of claim 21, wherein the temperature and the pressure comprise a predicted temperature and a predicted pressure received from a predictive soft sensor.

23. The method of claim 21, wherein the virtual flow meter is trained to predict three-phrase rates at surface separation condition in a system of wells.

24. The method of claim 21, comprising automatically retraining the predictive soft sensor on updated data in response to detecting that a prediction performance of a model of the virtual flow meter does not exceed a threshold.

25. The method of claim 21, further comprising executing an active learning and retraining the virtual flow meter on new data in response to detecting that an uncertainty or error of a model of the virtual flow meter exceeds a tolerance threshold.
